(19) United States
(12) Patent Application Publication
(10) Pub. No.: US 2009/0028526 A1
(43) Pub. Date: Jan. 29, 2009

(54) INFORMATION RECORDING APPARATUS AND METHOD, COMPUTER PROGRAM, AND INFORMATION RECORDING MEDIUM

(75) Inventor: Kazuo Kuroda, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 11/908,175

(22) PCT Filed: Mar. 3, 2006
(86) PCT No.: PCT/JP2006/304080

§ 371 Date: Sep. 10, 2007

(30) Foreign Application Priority Data
Mar. 8, 2005 (JP) 2005-063931

(51) Int. Cl. H04N 5/91

(52) U.S. Cl. 386/95; 386/E05.003

(57) ABSTRACT

An information recording device (200) includes: (i) conversion element (204, 206, etc.) for converting still image data into dynamic image data of a predetermined resolution; (ii) generation element (202a, etc.) for generating unique information (such as ID and CCI) on still image data (JPEG) and dynamic image data; (iii) first superimposing element (202) for superimposing the unique information on the still image data; (iv) second superimposing element (205) for superimposing the unique information on the dynamic image data; and (v) recording element (208) for recording still image data and dynamic image data on which the unique information has been superimposed, in an information recording medium.

### TECHNICAL FIELD

The present invention relates to an information recording medium, such as a DVD, an information recording apparatus and method for multiplexing proprietary information such as copyright protection information, to information such as a digital image, and for recording it onto the information recording medium, and a computer program which is executed on the information recording apparatus.

### BACKGROUND ART

Recently, as expected from generalization of digital media, rapid and a wide range of growth of the electronic publishing industry, digitalization of various multimedia contents, and rapid development of digital communication networks, such as the Internet, the world has been rapidly shifted from the analog era to the digital era. Moreover, these allow transmission and exchange of various multimedia data, such as E-books, internet TV, images, videos, and MP3. By using the various multimedia, the information people want can be obtained, quickly and easily.

However, various opposite functions have also appeared because of the shift to the digital era. That is, the following tendencies have appeared: the development of the digital technology allows a large amount of copies which are the same as an original, the development of the communication networks allows a large amount of distribution without a restriction, and a unique individual's creation is stolen inconsiderably.

In fact, illegal copying is a serious problem to be solved for companies which provide services of distributing (or transmitting) MP3 files, motion picture data (video), or the like on the Internet.

In particular, the digital data has such a property that an original and a copy cannot be distinguished because of its digital attribute, and for this reason, it is desired to rapidly seek a solution to copyright protection and authentication with respect to illegal copying, distribution, and modification of the digital data. More specifically, for example, if some still image data, which is obtained by taking a picture with a digital camera (or digital still camera) owned by an individual and which is based on a JPEG (Joint Photographic Experts Group) compression method or the like, is put on the Internet, the illegal copying of attribute information, such as picture composition, light intensity, focal distance, and angle of view, is easily performed on this still image data. In addition, information about the date that the picture of the still image data is taken and a person who takes the picture can be converted and removed by a third person, which makes it hard to confirm a real copyright holder.

Therefore, various copy protection technologies have been studied to effectively protect the copy of the digital data and to protect the copyright. As a method for this purpose, a study on digital watermark, which is known to be effective for protection of copying digital data, has been promoted actively. The “digital watermark” of the present invention is a technology of embedding, i.e. superimposing, data or the like about copyright protection, at the level that data is not changed in data reproduction or that the change cannot be perceived.

By using the digital watermark, as disclosed in a patent document 1, there is suggested a method of generating motion picture data from a plurality of still image data, which are continuously inputted, and of superimposing related information which indicates an association with the still image data, on the motion picture data by the digital watermark. Moreover, the following method has been already provided as recording software in the market; namely, a method of recording (i) the plurality of still image data which are continuously inputted and (ii) the motion picture data obtained by converting the plurality of still image data on the basis of a predetermined format, such as a DVD-Video format, onto a single information recording medium.

Hereinafter, the conventional method of embedding the digital watermark will be explained by using FIG. 10. FIG. 10 is a schematic diagram schematically showing a process of embedding (or superimposing) of the digital watermark, as a general example.

Firstly, a multiplier 50 multiplies proprietary information 20, such as copyright protection information, which is embedded as the digital watermark, by a gain factor k. Then, an embedding operator 51 replaces a bit value which is outputted from the multiplier 50 and a bit value of a brightness value (brightness information, a brightness signal) or color value (color information, a color signal) of a pixel in a predetermined position of an original image 52, to thereby generate an image 53 in which the proprietary information 20 is embedded as the digital watermark.

Specifically, in order to embed the proprietary information 20 by a pixel unit included in the original image, what is performed is an operation of replacing low-order n bits of the brightness information about the pixel in the predetermined position of one original image, by a predetermined value. More specifically, in order to embed the proprietary information 20 to 8-bit brightness information, the low-order 2 bits of the brightness information is used. In this case, with regard to the low-order 2 bits, 4 types of information of “00”, “01”, “10”, and “11” can be identified. The “00” information and the information other than “00” are identified to thereby embed the proprietary information.

Moreover, for example, there are about 720×480=345600 pixels per original image, so if the proprietary information 20 is embedded in eight of the pixels, it is possible to embed 1-byte proprietary information per original image. In general, an error correction code (ECC) is also added to the proprietary information. Thus, it is possible to add 4-byte error correction code or the like to 8-byte proprietary information per original image, to thereby embed about 12-byte information in total.

In order to extract the proprietary information 20 from the image 53 in which the digital watermark is embedded in the above manner, for example, if the proprietary information 20 is embedded as the digital watermark in a bit plane embedding method, the bit value of a bit plane value with the digital watermark embedded is extracted from the brightness information or color information of the pixel, and then the extracted data is divided by the gain factor k. That is how the proprietary information 20 can be extracted.

Patent document 1: Japanese Patent Application Laid Open NO. 2004-80095

### DISCLOSURE OF INVENTION

### Subject to be Solved by the Invention

In the patent document 1, however, the related information which indicates an association between the still image data and the generated motion picture data is only superimposed on at least one of the still image data and the motion picture by the digital watermark. In other words, since the proprietary information, such as copyright protection information, is not superimposed, there is such a technical problem that copyright protection cannot be realized in the still image data or the like.

Moreover, similarly, in the aforementioned recording software, the still image data or the motion picture data is not recorded onto the information recording medium under a condition that the proprietary information, such as copyright protection information, is superimposed on the still image data or the motion picture data.

Thus, there is such a technical problem that it is hardly possible to realize the copyright protection of the still image data or the motion picture data recorded which is recorded on the information recording medium.

Moreover, in the mechanism to protect the copyright described above, the data with both the digital watermark and the copyright protection information superimposed and the data without them are mixed on one recording medium. Thus, if a plurality of copyright protection information are separately used, there are the problem that the followings become unclear: (i) a history which indicates updating of the copyright protection information, (ii) a data copy route, and (iii) a source which indicates a copyright holder or the like.

Moreover, there is such a problem that there is no mechanism for copyright protection for comprehensively managing a large amount of copyrighted works which are created by individuals in the digital era.

It is therefore an object of the present invention to provide an information recording apparatus and method which can appropriately realize copyright protection of information, such as still image data and motion picture data, which is recorded onto an information recording medium, a computer program which makes a computer such an information recording medium, and an information recording medium.

### Means for Solving the Subject

(Information Reproducing Apparatus)

The above object of the present invention can be achieved by an information recording apparatus provided with: a converting device for converting still image data to motion picture data with a predetermined resolution; a generating device for generating proprietary information (ID and CCI) about at least one of the still image data (JPEG) and the motion picture data; a first superimposing device (or superimposing device for still image data) for superimposing the generated proprietary information (ID and CCI) on the still image data; a second superimposing device (or superimposing device for motion picture data) for superimposing the generated proprietary information (ID and CCI) on the motion picture data; and a recording device for recording the still image data and the motion picture data with the proprietary information superimposed, onto an information recording medium.

According to the information recording apparatus of the present invention, firstly, a plurality of still image data, which are continuously inputted, are converted by the converting device to the motion picture data on the basis of a predetermined format, such as a DVD-Video format. Incidentally, the converting device may convert the still image data to the motion picture data while reducing the resolution of the still image data.

Simultaneously with or before or after this, the proprietary information, such as identification information (ID: Identification number) and copyright protection information (CCI: Copy Control Information), is generated by the generating device.

The proprietary information is superimposed by the first superimposing device on the still image data in an image format based on the JPEG (Joint Photographic Experts Group) compression standard by e.g. digital watermark.

Simultaneously with or before or after this, the proprietary information is superimposed by the second superimposing device on the motion picture data.

Lastly, (i) the still image data with the proprietary information superimposed and (ii) the motion picture data with the proprietary information superimposed are recorded onto the information recording medium by the recording device.

As a result, since the proprietary information including e.g. the identification information is recorded on the information recording medium while being superimposed on the still image data and the motion picture data, it is possible to clarify the association between the still image data and the motion picture data which are recorded on the information recording medium. In addition, since the proprietary information including e.g. the copyright protection information is recorded on the information recording medium while being superimposed on the still image data and the motion picture data, it is possible to realize the copyright protection in the still image data and the motion picture data which are recorded on the information recording medium.

Moreover, according to the present invention, it is possible to realize a mechanism for copyright protection for comprehensively managing a large amount of copyrighted works which are created by individuals in the digital era. Specifically, it is possible to almost or completely eliminate the situation that the data with both the digital watermark and the copyright protection information superimposed and the data without them are mixed on one recording medium. Even if these data are mixed, a plurality of copyright protection information can be comprehensively managed.

As a result, for example, it is possible to clarify (i) a history which indicates updating of the copyright protection information, (ii) a data copy route, and (iii) a source which indicates a copyright holder or the like, to thereby realize the stronger copyright protection.

In one aspect of the information recording apparatus of the present invention, the converting device converts the still image data which holds a data amount corresponding to a high resolution (1600×1200) to the motion picture data which is formed of reduced still image data which holds a data amount corresponding to a low resolution (720×480).

According to this aspect, it is possible to convert, i.e. pixel-convert, the still image data to the motion picture data, more appropriately.

In another aspect of the information recording apparatus of the present invention, the converting device converts the still image data to the motion picture data on the basis of a predetermined format.

According to this aspect, it is possible to reproduce the content data with the proprietary information superimposed, in a user's desired aspect.

In an aspect associated with the predetermined format, the predetermined format may be (i) a DVD format or (ii) a Blu-ray format.

By virtue of such construction, it is possible to reproduce the content data with the proprietary information superimposed in the DVD format or the Blu-ray format, in a user's desired aspect. Specifically, the DVD format may be a DVD-VR format or a HD-DVD format.

In an aspect associated with the predetermined format, the predetermined format may be of a Motion-JPEG (Motion-Joint photographic Experts Group) type.

By virtue of such construction, it is possible to reproduce the content data with the proprietary information superimposed, i.e. Motion-JPEG contents, in a user's desired aspect.

In another aspect of the information recording apparatus of the present invention, the converting device converts the still image data to the motion picture data while reducing a data amount of the still image data to a data amount which is used for slide-show (picture-card show) reproduction.

According to this aspect, it is possible to perform the slide-show reproduction by using the plurality of still image data with the proprietary information superimposed. In other words, it is possible to perform the slide-show (picture-card show) reproduction in the motion picture format, with respect to the plurality of still image data with the proprietary information superimposed.

In another aspect of the information recording apparatus of the present invention, the first superimposing device superimposes the proprietary information on the still image data on the basis of digital watermark.

According to this aspect, the first superimposing device can superimpose the proprietary information, more appropriately.

In another aspect of the information recording apparatus of the present invention, the second superimposing device superimposes the proprietary information on the motion picture data on the basis of digital watermark.

According to this aspect, the second superimposing device can superimpose the proprietary information, more appropriately.

In another aspect of the information recording apparatus of the present invention, it is further provided with an inputting device for continuously inputting the still image data.

According to this aspect, the inputting device allows the still image data, which is obtained by taking a picture with a digital camera or the like and which is stored on a recording medium such as a SD (Secure Digital) memory card, to be inputted to the information recording apparatus.

In an aspect associated with the inputting device, the inputting device may include a first memory device (or still image data memory device) for storing the continuously inputted still image data.

By virtue of such construction, the still image data can be stored into the first memory device, such as a HDD, in the information recording apparatus.

In another aspect of the information recording apparatus of the present invention, the recording device includes a second memory device (or still image data/motion picture data memory device) for storing the still image data and the motion picture data with the proprietary information superimposed.

According to this aspect, the recording device can store (i) the still image data with the proprietary information superimposed, which is outputted by the first superimposing device, and (ii) the motion picture data with the proprietary information superimposed, which is outputted by the second superimposing device, into the second memory device, such as a HDD, in the information recording apparatus, in the recording operation.

In another aspect of the information recording apparatus of the present invention, the proprietary information includes (i) identification information (ID) which can identify at least the still image data and (ii) copyright protection information (CCI) about at least the still image data, the first superimposing device (or superimposing device for still image data) superimposes at least one of the identification information and the copyright protection information on the still image data as the proprietary information, and the second superimposing device (or superimposing device for motion picture data) superimposes the at least one of the identification information and the copyright protection information on the motion picture data as the proprietary information.

According to this aspect, since the proprietary information including e.g. the identification information is recorded on the information recording medium while being superimposed on the still image data and the motion picture data, it is possible to further clarify the association between the still image data and the motion picture data which are recorded on the information recording medium. In addition, since the proprietary information including e.g. the copyright protection information is recorded on the information recording medium while being superimposed on the still image data and the motion picture data, it is possible to realize the stronger copyright protection in the still image data and the motion picture data which are recorded on the information recording medium.

In an aspect associated with the second superimposing device, the second superimposing device (or superimposing device for motion picture data) may superimpose identification information (ID) which is identical to the identification information which can identify the still image data, on the motion picture data.

By virtue of such construction, it is possible to clarify the association between the still image data and the motion picture data by superimposing the proprietary information which includes the identical identification information, on the still image data and the motion picture data generated from the still image data. Moreover, it is possible to further simplify the management of the identification information by the information recording apparatus and a management center described later, i.e. verification or matching of the still image data and the motion picture data.

In an aspect associated with the first superimposing device and the second superimposing device, at least one of the first superimposing device (or superimposing device for still image data) and the second superimposing device (or superimposing device for motion picture data) may further add additional information to the identification information, the additional information indicating a data amount of at least one of the still image data and the motion picture data.

By virtue of such construction, it is possible to further simplify the management of the identification information by the information recording apparatus and the management center described later.

In another aspect of the information recording apparatus of the present invention, it is further provided with a communicating device which can communicate with a managing device (or management center) for managing at least the proprietary information (ID and CCI), through an external network.

According to this aspect, the communicating device allows the proprietary information to be transmitted to the managing device, such as a management center, through the external network, such as an optical fiber and ADSL.

In an aspect associated with the communicating device, the communicating device may register information to the managing device as the proprietary information, the information indicating at least one of (i) the identification information, (ii) copyright holder identification information which can identify a copyright holder to be protected by the copyright protection information, (iii) a date of reception or registration by the managing device, (iv) a registered place, (v) a data amount of the still image data or the motion picture data, and (vi) a particular block number (or address) in the still image data or the motion picture data, and data corresponding to the block number.

By virtue of such construction, since particular data is unambiguously registered on a particular date by the managing device, it is possible to realize the stronger copyright protection for the still image data and the motion picture data.

In an aspect associated with the communicating device, the communicating device may transmit not only the proprietary information but also at least the still image data (and the motion picture data) with the proprietary information superimposed, and the managing device may manage not only the proprietary information but also at least the still image data (and the motion picture data) with the proprietary information superimposed.

By virtue of such construction, for example, a user makes the managing device, which is a third-party organization, manage the content data itself, such as the still image data and the motion picture data, in addition to the proprietary information, so that it is possible to further increase convenience. Incidentally, the managing device may charge a user for management expenses on the basis of the data amount to be managed (or held).

In another aspect of the information recording apparatus of the present invention, the information recording medium is provided with: (i) a first data area to record therein first data (Navi) for reproducing contents in accordance with a predetermined format (DVD or Blu-ray format), (ii) a second data area to record therein second data (reduced data) which is reproduced with the first data (Navi), and (iii) a third data area to record therein third data (original data) which is associated with the second data (reduced data), and the recording device (iv) records reproduction control information (Navi) in the predetermined format into the first data area as the first data (Navi), (v) records the motion picture data with the proprietary information superimposed, into the second data area as the second data (reduced data), and (vi) records the still image data with the proprietary information superimposed, into the third data area as the third data (original data).

According to this aspect, the recording device may record (iv) the reproduction control information, such as Navigation Packet and Program Chain Information, for reproducing contents in accordance with the predetermined format, such as a DVD-Video format, into the first data area as the first data. In particular, the first data may be set to be non-rewritable or may be set to hold a read-only attribute. Alternatively, the first data may be set to be rewritable or may be set to be overwritten.

Moreover, the recording device may record (v) the motion picture data with the proprietary information superimposed, which is converted from the still image data described later, into the second data area as the second data. This motion picture data may be further reproduced with the reproduction control information as data for slide show in TV reproduction or an I picture. In particular, it may be constructed such that the content reproduction can be performed in accordance with the predetermined format by reproducing various data which are alternately arranged and which are recorded in both the first data area and the second area.

Moreover, the recording device may record (vi) e.g. the high-quality, large-capacity still image data with the proprietary information superimposed, into the third data area as the third data. Incidentally, if the size of the still image data which is recorded in the third data area is greater than a unit frame size of the motion picture data which is recorded in the second data area, the proprietary information may be divided into a plurality unit frames and embedded in the motion data in the second data area.

As described above, (i) the motion picture data on which the proprietary information is superimposed and which complies with the predetermined format and (ii) the still image data on which the proprietary information is superimposed are recorded onto one information recording medium. Therefore, it is possible to realize the protection of copyright which belongs to an individual, and at the same time, it is possible to comprehensively unify the management of a large amount of copyrighted works.

In an aspect associated with the information recording medium, the first data may be prerecorded in the first data area provided for the information recording medium, and the recording device may not record the reproduction control information as the first data (Navi).

By virtue of such construction, the first data may be set to be non-rewritable and set to hold a read-only attribute.

As described above, if the motion picture data with the proprietary information superimposed is recorded into the second data area on the information recording medium which has the prerecorded first data, it can be reproduced as the DVD-Video contents. Since various data other than the still image data and the motion picture data (e.g. a Navi pack, video pack, audio pack, VTSI, VTSM_VOBS, VTSI_BUP or the like) are prerecorded, a user does not have to record them. In other words, if a user purchases such an information recording medium, the user does not have to perform authoring to prepare the information recording medium on which desired DVD-Video contents are recorded. Thus, it is possible to significantly reduce a user's burden when the user records the DVD-Video contents onto the information recording medium and to significantly reduce a time required for the data recording.

In addition, even if the first data is prerecorded, (i) the motion picture data (or the second data) on which the proprietary information is superimposed and which complies with the predetermined format and (ii) the still image data (or the third data) on which the proprietary information is superimposed are recorded onto one information recording medium. Therefore, it is possible to realize the protection of copyright which belongs to an individual, and at the same time, it is possible to comprehensively unify the management of a large amount of copyrighted works.

In another aspect of the information recording apparatus of the present invention, the still image data is in an image format based on a JPEG (Join Photographic Experts Group) compression standard.

According to this aspect, it is possible to record the still image data and the motion picture data which is formed of the relevant still image data, onto the information recording medium, while the proprietary information is appropriately superimposed.

(Information Reproducing Method)

The above object of the present invention can be also achieved by an information recording method provided with: a converting process of converting still image data (JPEG) to motion picture data with a predetermined resolution; a generating process of generating proprietary information (ID and CCI) about at least one of the still image data and the motion picture data; a first superimposing process (or superimposing device for still image data) of superimposing the generated proprietary information (ID and CCI) on the still image data; a second superimposing process s (or superimposing device for motion picture data) of superimposing the generated proprietary information (ID and CCI) on the motion picture data; and a recording process of recording the still image data and the motion picture data with the proprietary information superimposed, onto an information recording medium.

According to the information recording method of the present invention, it is possible to receive the same various benefits as those of the information recording apparatus of the present invention.

Incidentally, in response to the aforementioned various aspects of the information recording apparatus of the present invention, the information recording method of the present invention can also employ various aspects.

(Computer Program)

The above object of the present invention can be also achieved by a computer program for recording control to control a computer provided in the aforementioned information recording apparatus of the present invention (including its various aspects), the computer program making the computer function as at least one portion of the converting device, the generating device, the first superimposing device, the second superimposing device, and the recording device.

According to the computer program of the present invention, the aforementioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the aforementioned information recording apparatus of the present invention, the computer program of the present invention can also employ various aspects.

The above object of the present invention can be also achieved by a computer program product in a computer-readable medium for tangibly embodying a program of instructions executable by a computer provided in the aforementioned information recording apparatus of the present invention (including its various aspects), the computer program product making the computer function as at least one portion of the generating device, the first superimposing device, the second superimposing device, and the recording device.

According to the computer program product of the present invention, the aforementioned information recording apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information recording apparatus of the present invention.

(Information Recording Medium)

The above object of the present invention can be also achieved by a first information recording medium on which still image data and motion picture data with proprietary information superimposed are recorded, the proprietary information being associated with at least one of the still image data and the motion picture data which is converted from the still image data to have a predetermined resolution.

According to the first information recording medium of the present invention, since the proprietary information including e.g. the identification information is recorded on the information recording medium while being superimposed on the still image data and the motion picture data, it is possible to clarify the association between the still image data and the motion picture data which are recorded on the information recording medium. In addition, since the proprietary information including e.g. the copyright protection information is recorded on the information recording medium while being superimposed on the still image data and the motion picture data, it is possible to realize the copyright protection in the still image data and the motion picture data which are recorded on the information recording medium.

Incidentally, in response to the various aspects of the aforementioned information recording apparatus of the present invention, the first information recording medium of the present invention can also employ various aspects.

In one aspect of the first information recording medium of the present invention, the still image data and the motion picture data with the proprietary information superimposed are recorded on the basis of (i) a DVD format or (ii) a Blu-ray format.

According to this aspect, it is possible to reproduce the content data with the proprietary information superimposed in the DVD format or the Blu-ray format, in a user's desired aspect.

In another aspect of the first information recording medium of the present invention, the still image data and the motion picture data with the proprietary information superimposed are recorded on the basis of a hierarchy structure for distinguishing a video area (Video_TS), an audio area (Audio_TS), and another area (User_DATA).

According to this aspect, for example, a user can reproduce DVD_Video contents, more appropriately.

The above object of the present invention can be also achieved by a second information recording medium to record thereon still image data and motion picture data with proprietary information superimposed are recorded, the proprietary information being associated with at least one of the still image data and the motion picture data which is converted from the still image data to have a predetermined resolution, the information recording medium provided with: a first data area to record therein first data for reproducing contents in accordance with a predetermined format (DVD or Blu-ray format); a second data area to record therein motion picture data which is reproduced with the first data and on which the proprietary information is superimposed; and a third data area to record therein the still picture data which is associated with the motion picture data and on which the proprietary information is superimposed.

According to the second information recording medium of the present invention, (i) the reproduction control information, such as Navigation Packet and Program Chain Information, for reproducing contents in accordance with the predetermined format, such as a DVD-Video format, may be recorded into the first data area as the first data. In particular, the first data may be set to be non-rewritable or may be set to hold a read-only attribute. Alternatively, the first data may be set to be rewritable or may be set to be overwritten.

Moreover, (ii) the motion picture data with the proprietary information superimposed, which is converted from the still image data described later, is recorded into the second data area as the second data. This motion picture data may be further reproduced with the reproduction control information as data for slide show in TV reproduction or an I picture. In particular, it may be constructed such that the content reproduction can be performed in accordance with the predetermined format by reproducing various data which are alternately arranged and which are recorded in both the first data area and the second area.

Moreover, (iii) e.g. the high-quality, large-capacity still image data with the proprietary information superimposed, having an original size, is recorded into the third data area as the third data. Incidentally, if the size of the still image data which is recorded in the third data area is greater than a unit frame size of the motion picture data which is recorded in the second data area, the proprietary information may be divided into a plurality unit frames and embedded in the motion data in the second data area. In particular, in one portion of the third data area, the still image data may be prerecorded as read-only data, such as background data.

As described above, (i) the motion picture data on which the proprietary information is superimposed and which complies with the predetermined format and (ii) the still image data on which the proprietary information is superimposed are recorded onto one information recording medium. Therefore, it is possible to realize the protection of copyright which belongs to an individual, and at the same time, it is possible to comprehensively unify the management of a large amount of copyrighted works.

Incidentally, in response to the various aspects of the aforementioned information recording apparatus of the present invention, the second information recording medium of the present invention can also employ various aspects.

In one aspect of the second information recording medium of the present invention, the first data is prerecorded in the first data area.

According to this aspect, the first data may be set to be non-rewritable or may be set to hold a read-only attribute.

As described above, if the motion picture data with the proprietary information superimposed is recorded into the second data area on the information recording medium which has the prerecorded first data, it can be reproduced as the DVD-Video contents. Since various data other than the still image data and the motion picture data (e.g. a Navi pack, video pack, audio pack, VTSI, VTSM_VOBS, VTSI_BUP or the like) are prerecorded, a user does not have to record them. In other words, if a user purchases such an information recording medium, the user does not have to perform authoring to prepare the information recording medium on which desired DVD-Video contents are recorded. Thus, it is possible to significantly reduce a user's burden when the user records the DVD-Video contents onto the information recording medium and to significantly reduce a time required for the data recording.

In addition, even if the first data is prerecorded, (i) the motion picture data (or the second data) on which the proprietary information is superimposed and which complies with the predetermined format and (ii) the still image data (or the third data) on which the proprietary information is superimposed are recorded onto one information recording medium. Therefore, it is possible to realize the protection of copyright which belongs to an individual, and at the same time, it is possible to comprehensively unify the management of a large amount of copyrighted works.

In another aspect of the first and second information recording media of the present invention, the information recording medium is used as a recording medium of an electrophotographic album.

According to this aspect, the information recording medium can be used as a recording medium which constitutes an electrophotographic album.

These effects and other advantages of the present invention will become more apparent from the embodiments explained below.

As explained above, according to the information recording apparatus of the present invention, it is provided with the converting device, the generating device, the first superimposing device, the second superimposing device, and the recording device. According to the information recording method of the present invention, it is provided with the converting process, the generating process, the first superimposing process, the second superimposing process, and the recording process. Therefore, since the proprietary information including e.g. the copyright protection information is recorded on the information recording medium while being superimposed on the still image data and the motion picture data, it is possible to realize the copyright protection in the still image data and the motion picture data which are recorded on the information recording medium.

Moreover, according to the computer program of the present invention, it makes a computer function as the aforementioned information recording apparatus of the present invention. Therefore, it enables the information recording apparatus to multiplex the proprietary information, such as copyright protection information, more appropriately.

Moreover, according to the first and second information recording media of the present invention (each including its various aspects), each of them is provided with the first data area and the second data area. Therefore, it is possible to preferably record the still image data and the motion picture data in appropriate association with the prerecorded first data, and it is possible to reduce a burden or load required to prepare the information recording medium with the content data recorded.

### BRIEF DESCRIPTION OF DRAWINGS

FIG. 1 is an outline plan view showing the basic structure of an optical disc in an embodiment of the information recording medium of the present invention, wherein the structure of the optical disc having a plurality of areas is shown in an outline plan view on the upper side, and an area structure in the radial direction is correspondingly shown in a conceptual view on the lower side.

FIG. 2 is an explanatory diagram conceptually showing further segmentalized recording areas in a user data area 106 in the embodiment of the present invention.

FIG. 3 is another explanatory diagram conceptually showing further segmentalized recording areas in a user data area 106 in the embodiment of the present invention.

FIG. 4 is a directory tree view showing a logical hierarchy structure of the optical disc in the embodiment of the present invention.

FIG. 5 is an explanatory diagram conceptually showing the basic structure of a slide show in the embodiment of the present invention.

FIG. 6 is a block diagram showing the basic structure of a first embodiment of the information recording apparatus of the present invention.

FIG. 7 is a flowchart showing the operation principle of the first embodiment of the information recording apparatus of the present invention.

FIG. 8 is a block diagram showing the basic structure of a second embodiment of the information recording apparatus of the present invention.

FIG. 9 is a flowchart showing the operation principle of the second embodiment of the information recording apparatus of the present invention.

FIG. 10 is a schematic diagram schematically showing a process of embedding (or superimposing) of digital watermark, as a general example.

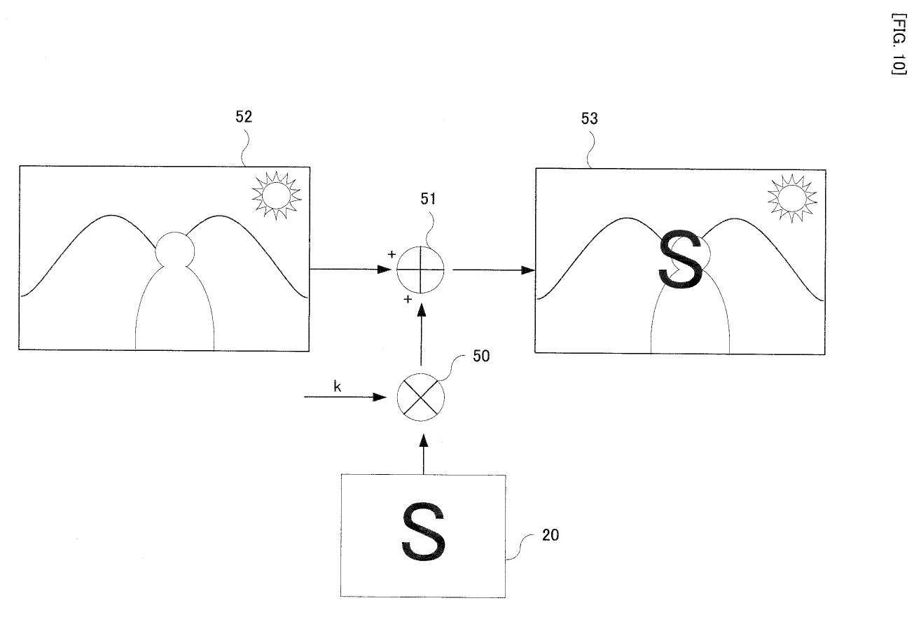

### DESCRIPTION OF REFERENCE CODES

1 still image data
1a reduced still image data
2 motion picture data
100 optical disc
106 user data area
111 DVD-Video file area
112 still image data area
113 position data area
122 rewritable area
200 information recording/reproducing apparatus
201 HDD
202 first superimposition device
202a first generator
203 CPU
204 reduction device
205 second superimposition device
205a second generator
206 motion picture data forming device
207 HDD
208 optical disc drive
209 communication device
300 management center

### BEST MODE FOR CARRYING OUT THE INVENTION

Hereinafter, the best mode for carrying out the present invention will be explained in each embodiment in order with reference to the drawings.

### (1) Information Recording Medium

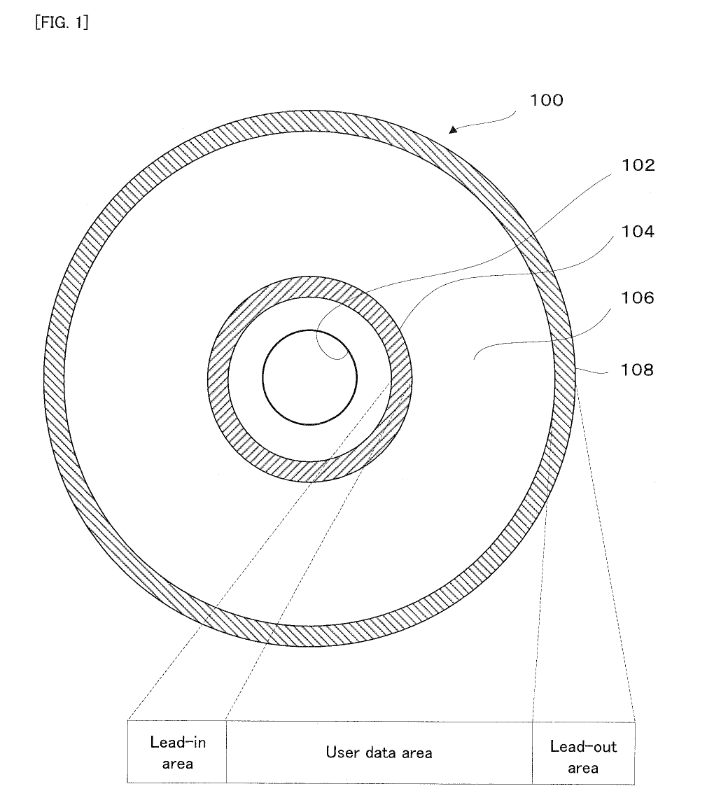

Firstly, with reference to FIG. 1 to FIG. 5, an embodiment of the information recording medium of the present invention will be explained.

(1-1) Basic Structure

Firstly, with reference to FIG. 1, an explanation will be given on the basic structure of an optical disc in the embodiment of the information recording medium of the present invention. FIG. 1 is an outline plan view showing the basic structure of the optical disc in the embodiment of the information recording medium of the present invention, wherein the structure of the optical disc having a plurality of areas is shown in an outline plan view on the upper side, and an area structure in the radial direction is correspondingly shown in a conceptual view on the lower side.

As shown in FIG. 1, an optical disc 100 allows data to be recorded thereon in various recording methods, such as a magneto optical method and a phase change method, for a plurality of times or only once. Then, as in a DVD, on a recording surface on the disc main body with a diameter of about 12 cm, the optical disc 100 is provided with: a center hole 102 as the center; a lead-in area 104; a user data area 106; and a lead-out area 108, from the inner circumference to the outer circumference. In each area, there are alternately provided groove tracks GT and land tracks LT, spirally or concentrically, centered on the center hole 102. The groove track GT may be wobbled, and pre-pits may be formed on one or both of these tracks.

Incidentally, the present invention is not limited to the optical disc having the three areas described above. For example, even if the lead-in area 104 or the lead-out area 108 does not exist, a file structure explained below can be established. Moreover, the lead-in area 104 or the lead-out area 108 may be further segmentalized.

Moreover, the optical disc 100 in the embodiment is not limited to an optical disc having one recording layer but may be of a two-layer single sided type (i.e. dual layer) or a two-layer double sided type (i.e. dual layer double side). Moreover, it is not limited to an optical disc having two recording layers, but may be a multilayer type optical disc having three or more layers.

(1-2) Data Structure

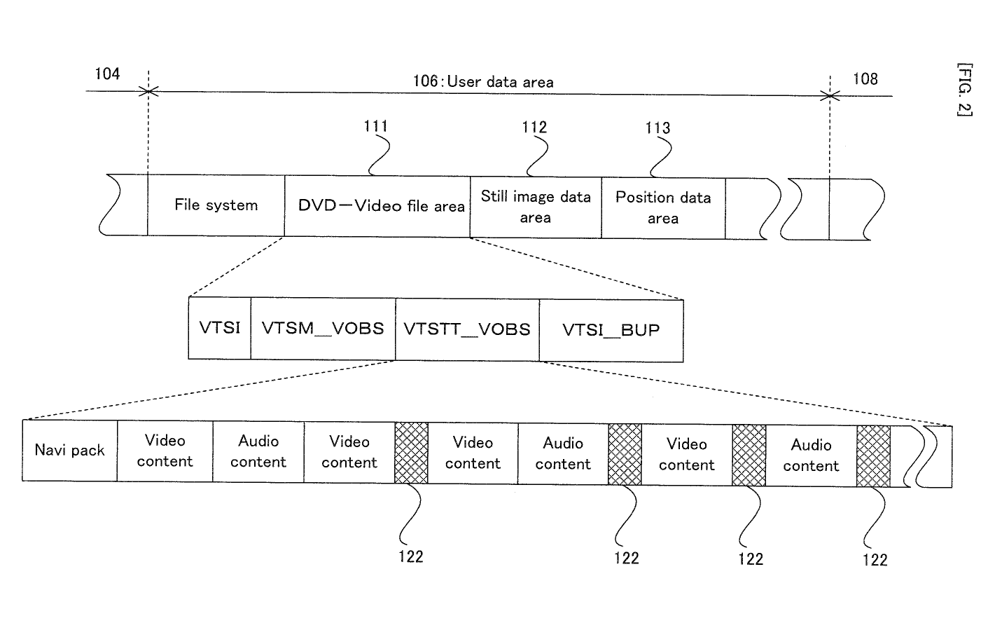

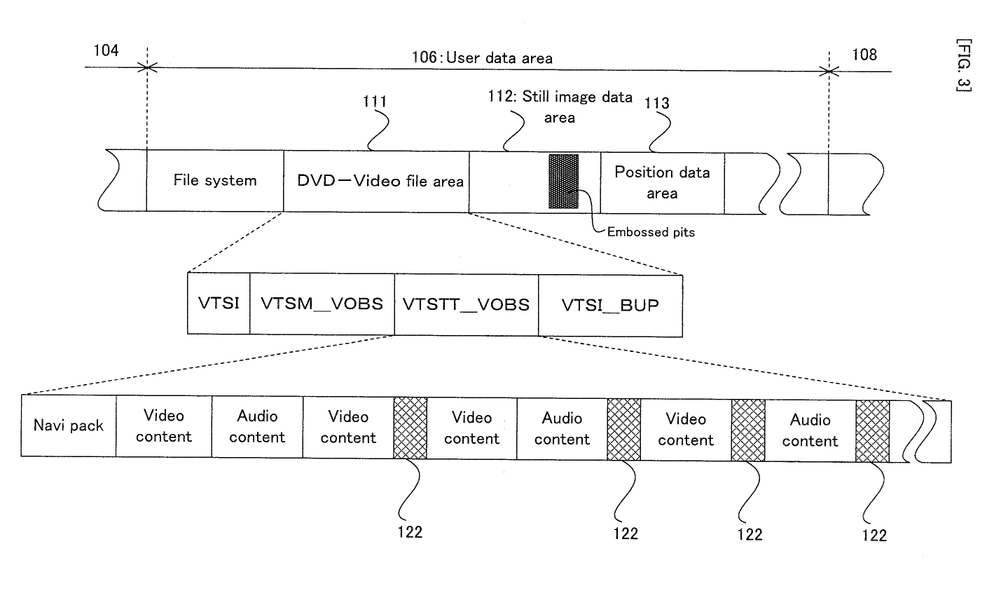

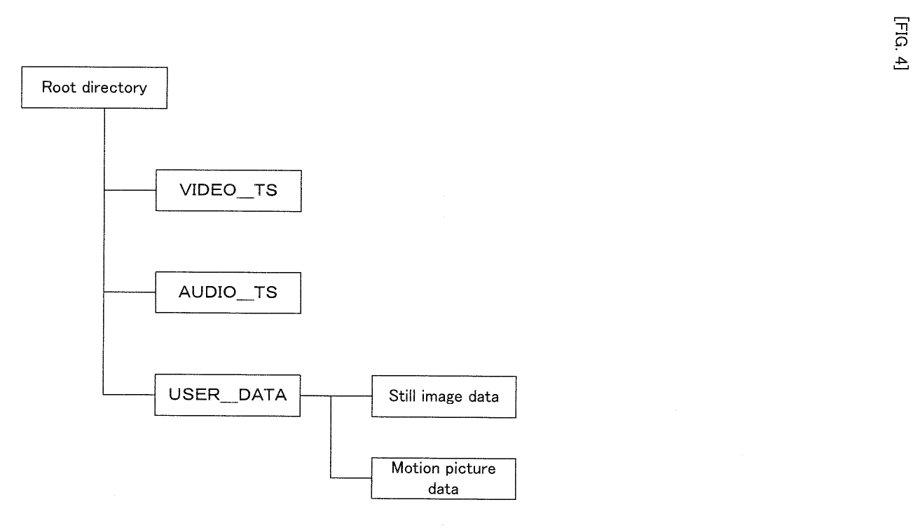

Next, with reference to FIG. 2 to FIG. 4, an explanation will be given on a specific data structure of the optical disc in the embodiment. FIG. 2 is an explanatory diagram conceptually showing further segmentalized recording areas in a user data area 106 in the embodiment of the present invention. FIG. 3 is another explanatory diagram conceptually showing further segmentalized recording areas in a user data area 106 in the embodiment of the present invention. FIG. 4 is a directory tree view showing a logical hierarchy structure of the optical disc in the embodiment of the present invention.

As shown in FIG. 2, the user data area 106 is provided with: a file system; a DVD-Video file area 111; a still image data area 112; and a position data area 113.

The file system includes various control information used to reproduce various data (or various files) which are recorded onto the optical disc 100.

The DVD-Video file area 111 is a recording area to record therein a DVD-Video file which is used to reproduce DVD-Video contents. In the DVD-Video file area 111, as shown in the middle part of FIG. 2, VTSI (Video Title Set Information), VTSM_VOBS (Video Object Set for VTS Menu), VTSTT_VOBS (Video Object Set for Titles in VTS), and VTSI_BUP (VTSI Back Up) are recorded as the DVD-Video file. Incidentally, to explain it in more detail, a not-illustrated VMG (Video Manager) file and a plurality of VTS files are recorded into the DVD-Video file area 111 as the DVD-Video file, and each of the VTS files includes the aforementioned VTSI, VTSM_VOBS, VTSTT_VOBS, and VTSI_BUP.

Then, the VTSTT_VOBS, which is the entity of the DVD-Video contents to be reproduced, includes a Navi pack, a video pack, an audio pack, or the like. Therefore, these packs are read by e.g. an information recording apparatus, to thereby reproduce the DVD-Video contents.

In the embodiment, particularly, one portion of the recording area in which the VTSTT_VOB is recorded (i.e. one portion of the DVD-Video file area 111) is provided with a rewritable area 122 in which the data recorded in the one portion can be rewritten. In the rewritable area 122, there is recorded the motion picture data which is converted from the original still image data to have predetermined resolution and a predetermined size and on which the proprietary information is superimposed.

In the rewritable area 122, predetermined data may be prerecorded in a rewritable condition, or no data may be recorded. On the other hand, the aforementioned Navi pack, video contents, and audio contents (and further, VTSI, VIST_VOBS, VTSI_VUP, or the like) which are recorded in another part of recording area are recorded, in a non-rewritable condition (or in a read-only condition), by using embossed pits, pre-record marks or the like. That is, the rewritable area 122 constitutes one specific example of the “second data area” of the present invention, and the other recording areas other than the rewritable area 122 out of the DVD-Video file area 111 constitute one specific example of the “first data area” of the present invention. Then, each of the files prerecorded in the DVD-Video file area 111 constitutes one specific example of the “first data” of the present invention. Moreover, the rewritable area 122 preferably has a data amount which is an integral multiple of 1 ECC block (or 1 sector).

The still image data area 112 is one specific example of the “third data area” of the present invention. The still image data area 112 is a recording area to record therein still image data (i.e. one specific example of the “still image data” and the “third data” of the present invention), such as JPEG data and bitmap data, on which the proprietary information is superimposed including e.g. identification information and copyright protection information. The still image data with the proprietary information superimposed, which is recorded in the still image data area 112, may be recorded in a non-rewritable condition, by using embossed pits, pre-record marks or the like, as shown in FIG. 3.

Alternatively, the still image data may be recorded in a rewritable condition by using e.g. record marks which are formed by irradiating laser light.

The position data area 113 is a recording area to record therein address information or the like which can specify the position of the rewritable area 122 which is provided in the DVD-Video file area. The address information or the like may indicate an address position (or offset address value or the like) of the rewritable area 122, or a track number of the rewritable area 122, or the like. Moreover, if there are a plurality of rewritable areas 122, each of the positions of the plurality of rewritable areas 122 is indicated by the address information or the like. Moreover, the address information or the like, which is recorded in the position data area 113, may be recorded in a non-rewritable condition by using embossed pits, pre-record marks or the like.

Furthermore, on the optical disc, a logical hierarchy based on the DVD-Video standard or DVD-Audio standard may be established, as shown in FIG. 4. Specifically, in the next hierarchy of a root directory, there may be established (i) a “VIDEO_TS” directory to record the motion picture data with the proprietary information superimposed, (ii) an “AUDIO_TS” directory to record therein audio data, and (iii) a “USER_DATA” to record therein user data. Moreover, in the “USER_DATA”, there may be recorded the still image data with the proprietary information superimposed, and the motion picture data (i.e. one specific example of the “motion picture data of the present invention) with the proprietary information superimposed. Incidentally, on the optical disc, a logical hierarchy based on the Video CD standard may be established.

As described above, if the motion picture data, such as an I picture, which is converted from the still image data and on which the proprietary information is superimposed, is recorded into the rewritable area 122, it can be reproduced as the DVD-Video contents including the relevant still image data. Since various data other than the still image data (e.g. the Navi pack, video pack, audio pack, VTSI, VTSM_VOBS, VTSI_BUP or the like) are prerecorded, a user does not have to record them. In other words, if a user purchases such an optical disc 100, the user does not have to perform authoring to prepare the optical disc 100 on which desired DVD-Video contents are recorded. Thus, it is possible to significantly reduce a user's burden when the user records the DVD-Video contents onto the optical disc 100 and to significantly reduce a time required for the data recording. This can be achieved because the read-only (i.e. non-rewritable) recording area and the rewritable recording area are not clearly distinguished but are mixed, like the optical disc 100 in the embodiment.

Moreover, by appropriately changing (i.e. rewriting) the motion picture data, such as an I picture, which is recorded into the rewritable area 122, which is converted from the still image data and on which the proprietary information is superimposed, it is possible to reproduce the various types of DVD-Video contents including various sub-picture packs. This allows a user to watch the various types of DVD-Video contents. For example, in case of DVD-Video contents which use the still image data with the proprietary information superimposed as background data, the background image can be changed depending on a user's preference, as occasion demands.

In addition, since the various data other than the motion picture data, such as an I picture, which is converted from the still image data and on which the proprietary information is superimposed, are prerecorded in a non-rewritable condition by using embossed pits, pre-record marks or the like, it is possible to effectively prevent such a disadvantage that a user's operation causes mistaken overwriting and deletion.

Incidentally, the present invention is not limited to the aspect that the motion picture data, such as an I picture, which is converted from the still image data and on which the proprietary information is superimposed, is recorded into the rewritable area 122, as described above, but the other data such as the Navi pack (or script data, program data, file system or the like which is used for the reproduction of the DVD-Video file) may be recorded into the rewritable area 122. Alternatively, the audio data may be recorded into the rewritable area 122. The point is if one portion of data is prerecorded in the format that corresponds to application for the reproduction on the optical disc 100, and if another portion of data is recorded into the rewritable area 122, it is possible to receive the advantages, such as reducing the burden required for the authoring, as described above. In other words, in case of the optical disc 100 on which a format image file (i.e. a file as a frame having a form as a format) is prerecorded and on which another data which is actually recorded (e.g. video data, audio data, still image data, or the like) can be recorded (or rewritten) in a predetermined position of the image file, the aforementioned various benefits can be received.

The present invention is not limited to the optical disc 100 for reproducing the DVD-Video describe above, but may be an optical disc in a format according to other various applications. For example, it may be in a DVD-VR format for real-time recording. For example, it may be an optical disc which can reproduce a slide show of the still image data with the proprietary information superimposed, or the like. That is, if the application or the like to run the slide show is prerecorded in the recording area other than the rewritable area 122 in the format to run the slide show, then the slide show can be run by recording the motion picture data, such as an I picture, which is converted from the still image data and on which the proprietary information is superimposed, into the rewritable area 122.

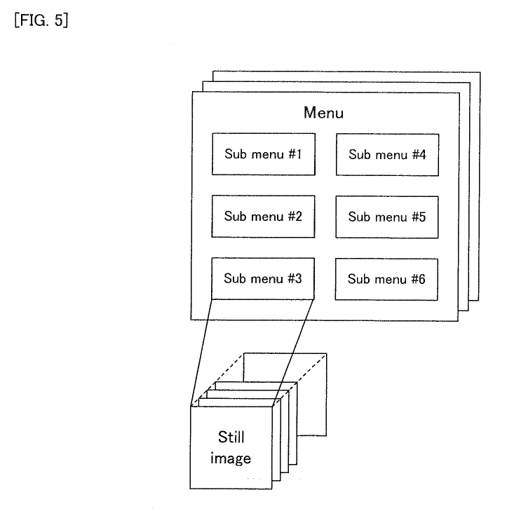

The slide show will be explained more specifically by showing FIG. 5. FIG. 5 is an explanatory diagram conceptually showing the basic structure of the slide show in the embodiment of the present invention.

For example, data which defines the basic structure of the slide show (e.g. the basic structure of a menu screen and a sub-menu screen or the like shown in FIG. 5) is prerecorded in a form of the format to run the slide show, by using embossed pits or the like. For example, the data (so-called data as a frame) which defines the basic structure provided with a plurality of menu screens, each of which has six sub-menu screens, is prerecorded in a form of the format to run the slide show, by using embossed pits or the like, wherein the sub menu screen can reproduce the motion picture data in the slide show, and the motion picture data is converted from 99 pieces of still image data with the proprietary information superimposed. The still image data with the proprietary information superimposed, which is actually used for the slide show, is recorded into the rewritable area 122, as the still image data on which the proprietary information is superimposed by a user. If there are recorded more than the number of the still image data with the proprietary information superimposed, which can be displayed on the first menu screen (e.g. the number of the still image data which can be displayed on the six sub-menu screens), then the second menu screen, the third menu screen and so on are newly generated sequentially, on the basis of the data which defines the basic structure of the slide show prerecorded. Moreover, if any still image data or the like with the proprietary information superimposed has been not recorded yet, a default image which is prerecorded as initial data may be displayed on the first menu screen or the like. Therefore, a user can relatively easily prepare the optical disc 100 on which the slide-show reproduction can be performed by using the still image data with the desired proprietary information superimposed, without the authoring process or the like.

Of course, the present invention may correspond to other applications other than the slide show. For example, in the case that the optical disc 100 in the embodiment is applied to game software or the like, if different data (or files) is recorded into the rewritable area 122 in response to stage clear, game 6 clear or the like, a user can enjoy various game scenes, such as playing a game on the basis of different scenarios, going on to a bonus stage or the like, and seeing a different ending screen.

### (2) Details of First Embodiment of Information Recording Apparatus

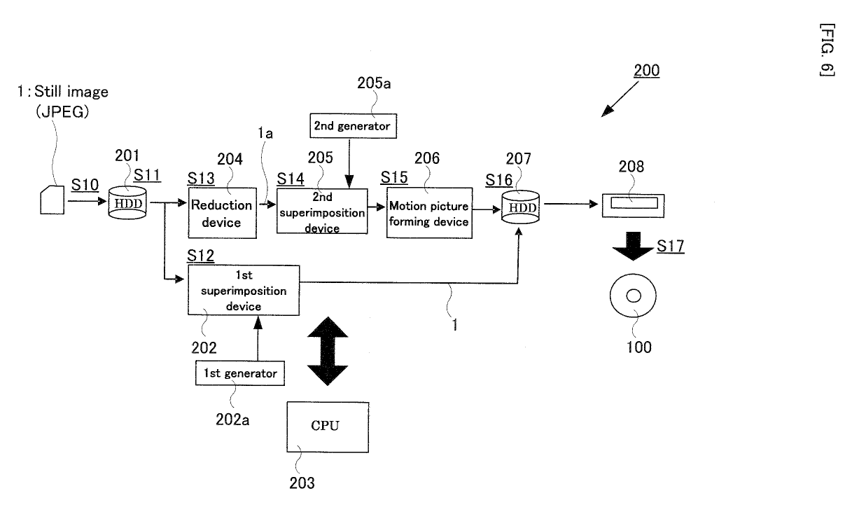

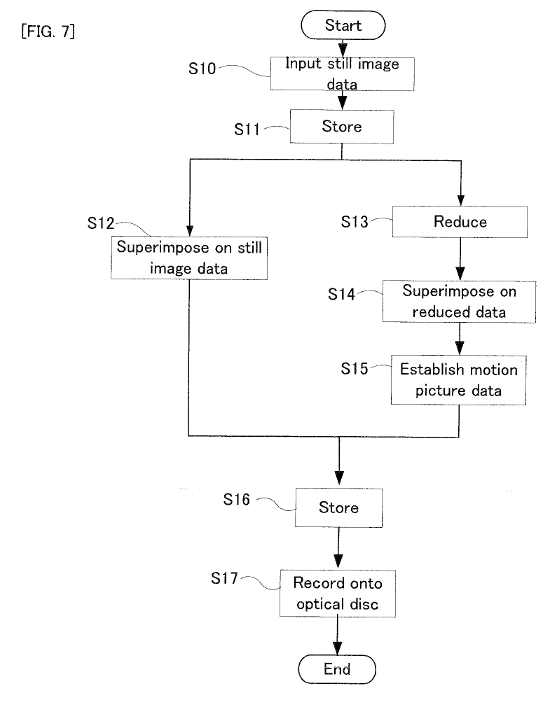

Next, with reference to FIG. 6 and FIG. 7, an explanation will be given on the basic structure and the operation principle of a first embodiment of the information recording apparatus of the present invention. FIG. 6 is a block diagram showing the basic structure of the first embodiment of the information recording apparatus of the present invention.

(2-1) Basic Structure

As shown in FIG. 6, an information recording apparatus 200 in the first embodiment of the present invention is provided with: a HDD (Hard Disk Drive) 201; a first superimposition device 202; a first generator 202a; a CPU 203; a reduction device 204; a second superimposition device 205; a second generator 205a; a motion picture data forming device 206; a HDD 207; and an optical disc drive 208.

(2-2) Operation Principle

Next, with reference to the aforementioned FIG. 6, as occasion demands, in addition to FIG. 7, an explanation will be given on the detailed structure in addition to the operation principle of the first embodiment of the information recording apparatus of the present invention. FIG. 7 is a flowchart showing the operation principle of the first embodiment of the information recording apparatus of the present invention.

As shown in FIG. 7, firstly, still image data 1 is inputted to the HDD 201 in the information recording apparatus 200 (step S10), wherein the still image data 1 is in an image format based on the JPEG compression standard, the still image data 1 is obtained by taking a picture with a digital camera or the like, and the still image data 1 is stored on a recording medium such as a SD (Secure Digital) memory card.

Then, the still image data 1 is recorded onto the HDD 201 (step S11).

Then, under the control of a controlling device such as the CPU 203, the proprietary information, such as identification information (ID: identification number) and copyright protection information (CCI: Copy Control Information), is superimposed by the first superimposition device 202 on the still image data 1 by e.g. digital watermark (step S12). In particular, the proprietary information may be generated by the first generator 202a, as occasion demands. The “identification information” in the present invention is information which can uniquely identify the still image data 1. Specifically, giving not only a manufacturer's identification number to the recording medium, such as a SD card, but also a serial number, which is given to each of still image data recorded in the recording medium, as the identification information of the still image data 1 may allow the still image data 1 to be uniquely identified.

Incidentally, additional information which indicates the data amount of the still image data 1 may be added to the identification information of the still image data 1. Moreover, the “copyright protection information” in the present invention is information about copyright protection of the still image data. Specifically, if the copyright protection information of the still image data 1 is CCI (Copy Control Information) which is information to manage copy generation, its data amount is 2 bits. More specifically, it can show the following three types of information: “11” which means Never Copy, “10” which means Copy Once, and “00” which means Copy Free.

Simultaneously with or before or after the step S12, under the control of the CPU 203, the resolution of the still image data 1, which is outputted by the HDD 201, is reduced by the reduction device 204, for example, from a high resolution of 1600×1200 to a low resolution of 780×480 for the slide show reproduction as the motion picture data (step S13).

Then, under the control of the CPU 203, the proprietary information such as the identification information (ID) and the copyright protection information (CCI) is superimposed by the second superimposition device 205 on the reduced still image data 1a (step S14). In particular, the proprietary information may be generated by the second generator 205a, as occasion demands.

Incidentally, the identification information which is superimposed on the reduced still image data 1a may be identical to the identification information which is superimposed on the still image data 1 by the first superimposition device 202 described above. Moreover, additional information which indicates the data amount of the still image data 1a may be added to the identification information of the reduced still image data 1a.

Then, under the control of the CPU 203, the reduced still image data 1a with the proprietary information superimposed is established by the motion picture data forming device 206 as motion picture data 2, on the basis of a predetermined format, such as a DVD-Video format (step S15). More specifically, the reduced still image data 1a with the proprietary information superimposed is encoded (or coded) by the motion picture data forming device 206, on the basis of a coding method, such as MPEG-2 (Moving Picture Experts Group-2), and it is converted on the basis of the DVD-Video format or Video CD format. Then, if there is recordable audio data, music data, or the like, it may be also encoded simultaneously with the encoding of the image. Alternatively, it may be encoded on the DVD-Video format by PCM (Pulse Code Modulation).

Incidentally, the superimposition of the proprietary information in the step S14 described above may be performed simultaneously with or before or after the step S15. In this case, the identification information which is superimposed on the motion picture data 2, which is formed of the reduced still image data 1a, may be identical to the identification information which is superimposed on the still image data 1 by the first superimposition device 202 described above. Moreover, additional information which indicates the data amount of the motion picture data 2, which is formed of the reduced still image data 1a, may be added.

Then, (i) the still image data with the proprietary information superimposed, which is outputted by the first superimposition device 202, and (ii) the motion picture data 2, which is outputted by the motion picture data forming device 206 are stored onto the HDD 206 (step S16).

Then, (i) the still image data with the proprietary information superimposed and (ii) the motion picture data 2 which is formed of the still image data 1 with the proprietary information superimposed, both of which are outputted from the HDD 207, are recorded by the “recording device” of the present invention, such as the optical disc drive 208, onto an information recording medium, such as the optical disc 100 (step S17).

As a result, it is possible to clarify an association between the still image data 1 and the motion picture data 2 by superimposing the proprietary information which includes e.g. the identification information, on the still image data 1 and the motion picture data 2 generated from the still image data 1. In addition, it is possible to realize the copyright protection in the still image data 1 and the motion picture data 2 generated from the still image data 1, by superimposing the proprietary information which includes e.g. the copyright protection information, on the still image data 1 and the motion picture data 2.

Moreover, since the proprietary information including e.g. the identification information is recorded on the information recording medium while being superimposed on the still image data 1 and the motion picture data 2, it is possible to clarify the association between the still image data 1 and the motion picture data 2 which are recorded on the information recording medium. In addition, since the proprietary information including e.g. the copyright protection information is recorded on the information recording medium while being superimposed on the still image data 1 and the motion picture data 2, it is possible to realize the copyright protection in the still image data 1 and the motion picture data 2 which are recorded on the information recording medium.

### (3) Details of Second Embodiment of Information Recording Apparatus

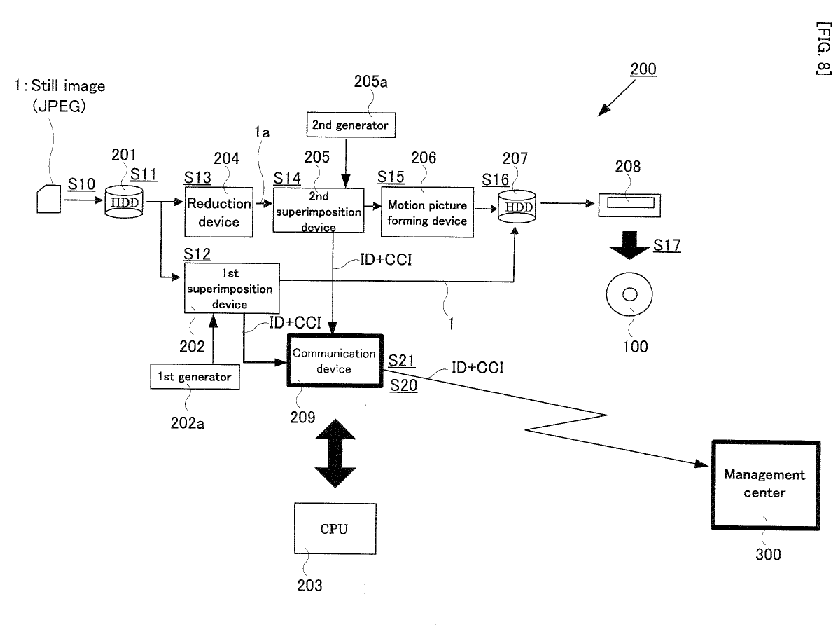

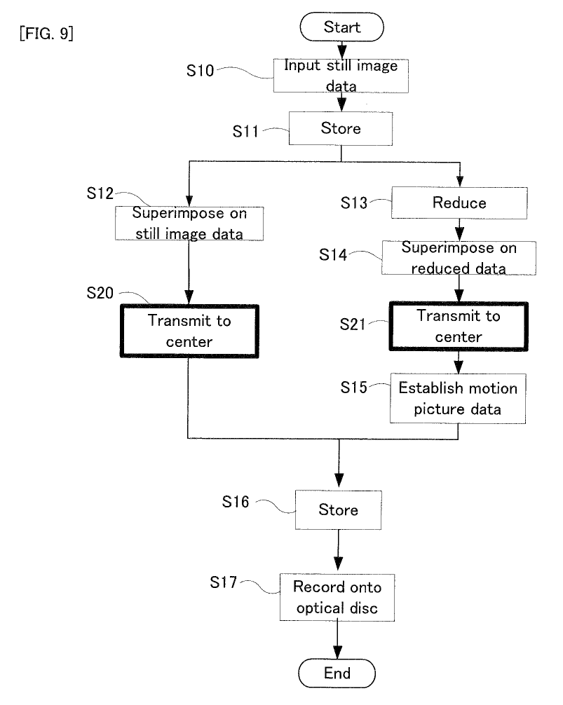

Next, with reference to FIG. 8 and FIG. 9, an explanation will be given on the basic structure and the operation principle of a second embodiment of the information recording apparatus of the present invention. Incidentally, the basic structure and the operation principle of the second embodiment are substantially the same as those in the first embodiment. FIG. 8 is a block diagram showing the basic structure of the second embodiment of the information recording apparatus of the present invention.

(3-1) Basic Structure

As shown in FIG. 8, an information recording apparatus 200 in the second embodiment of the present invention is further provided with a communication device 209 in addition to the basic structure of the first embodiment described above. The communication device 209 enables the information recording apparatus 200 to communicate with a management center 300 through an external network, such as the Internet.

(3-2) Operation Principle

Next, with reference to the aforementioned FIG. 8, as occasion demands, in addition to FIG. 9, an explanation will be given on the detailed structure in addition to the operation principle of the second embodiment of the information recording apparatus of the present invention. FIG. 9 is a flowchart showing the operation principle of the second embodiment of the information recording apparatus of the present invention. Incidentally, in each process in FIG. 9, the same steps as those in the process in FIG. 7 related to the first embodiment described above carry the same step numbers, and the explanation thereof will be omitted as occasion demands.

As shown in FIG. 9, after the aforementioned step S12, the proprietary information, which includes the identification information (ID), the copyright protection information (CCI) or the like and which is superimposed on the still image data 1, is transmitted by the communication device 209 to the management center 300 (step S20).

Moreover, after the aforementioned step S14, the proprietary information, which includes the identification information (ID), the copyright protection information (CCI) or the like and which is superimposed on the still image data 1, which constitutes the motion picture data 2, is transmitted by the communication device 209 to the management center 300 (step S21). Incidentally, in the aforementioned step S20 and step S21, furthermore, the original still image data without the proprietary information superimposed and the high-quality still image data with the proprietary information superimposed may be transmitted to the management center 300. The transmitted various information is managed on the management center 300.

More specifically, information which indicates the following five things may be registered by the management center 300 as the proprietary information.

That is, (i) the identification information (ID), (ii) copyright holder identification information which can identity a copyright holder (or registrant) to be protected by the copyright protection information (CCI), (iii) a date of reception or registration by the management center 300, (iv) a registered place, such as a country name, (v) the data amount of the still image data 1 or the motion picture data 2, and (vi) information which indicates a particular block number (or address) in the still image data 1 or the motion picture data 2, and data corresponding to the block number.

As a result, it is possible to clarify the association between the still image data and the generated motion picture data, on the basis of the proprietary information including e.g. the identification information, which is managed by the management center, which is a third-party organization. Moreover, since particular data is (unambiguously) registered, by the definition (or with one to one relationship), on a particular date on the basis of the proprietary information including e.g. the copyright protection information, which is managed by the management center, which is a third-party organization, it is possible to realize the stronger copyright protection in the still image data 1 and the motion picture data 2.

In the aforementioned embodiments, the optical disc 100 is explained as one example of the information recording medium, and the recorder related to the optical disc 100 is explained as one example of the information recording medium. The present invention, however, is not limited to the optical disc and the recorder thereof, and can be applied to other various information recording media which support high-density recording or high transfer rate and their recorders (e.g. a CD, Blu-ray disc, HDDVD or the like and their recorders).

The present invention is not limited to the aforementioned embodiment, and various changes may be made without departing from the essence or spirit of the invention which can be read from the claims and the entire specification. An information recording apparatus and method, a computer program for recording control, and an information recording medium, which involve such changes, are also intended to be within the technical scope of the present invention.

### INDUSTRIAL APPLICABILITY

The information recording apparatus and method, the computer program, and the information recording medium according to the present invention can be applied to a high-density optical disc, such as a DVD, and further applied to an information recording apparatus, such as a DVD recorder. Moreover, they can be applied to the information recording apparatus or the like which is mounted on various computer equipment for consumer use or for commercial use, or which can be connected to various computer equipment.

1. An information recording apparatus comprising:
a converting device for converting still image data to motion picture data with a predetermined resolution;
a generating device for generating proprietary information which includes identification information which can uniquely identify an association between the still image data and the motion picture data, with respect to another still image data and another motion picture data;
a first superimposing device for superimposing the generated proprietary information on the still image data;
a second superimposing device for superimposing the generated proprietary information on the motion picture data; and
a recording device for recording the still image data and the motion picture data with the proprietary information superimposed, onto an information recording medium.

2. The information recording apparatus according to claim 1, wherein said converting device converts the still image data which holds a data amount corresponding to a high resolution to the motion picture data which is formed of reduced still image data which holds a data amount corresponding to a low resolution.

3. The information recording apparatus according to claim 1, wherein said converting device converts the still image data to the motion picture data on the basis of a predetermined format.

4. The information recording apparatus according to claim 3, wherein the predetermined format is (i) a DVD format or (ii) a Blu-ray format.

5. The information recording apparatus according to claim 3, wherein the predetermined format is of a Motion-JPEG (Motion-Joint photographic Experts Group) type.

6. The information recording apparatus according to claim 1, wherein said converting device converts the still image data to the motion picture data while reducing a data amount of the still image data to a data amount which is used for slide-show reproduction.

7. The information recording apparatus according to claim 1, wherein said first superimposing device superimposes the proprietary information on the still image data on the basis of digital watermark.

8. The information recording apparatus according to claim 1, wherein said second superimposing device superimposes the proprietary information on the motion picture data on the basis of digital watermark.

9. The information recording apparatus according to claim 1, further comprising an inputting device for continuously inputting the still image data.

10. The information recording apparatus according to claim 9, wherein said inputting device includes a first memory device for storing the continuously inputted still image data.

11. The information recording apparatus according to claim 1, wherein said recording device includes a second memory device for storing the still image data and the motion picture data with the proprietary information superimposed.

12. The information recording apparatus according to claim 1, wherein
the proprietary information includes (i) identification information (ID) which can identify at least the still image data and (ii) copyright protection information (CCI) about at least the still image data,
said first superimposing device superimposes the identification information and the copyright protection information on the still image data as the proprietary information, and
said second superimposing device superimposes the identification information and the copyright protection information on the motion picture data as the proprietary information.

13. The information recording apparatus according to claim 12, wherein said second superimposing device superimposes identification information which is identical to the identification information which can identify the still image data, on the motion picture data.

14. The information recording apparatus according to claim 12, wherein at least one of said first superimposing device and said second superimposing device further adds additional information to the identification information, the additional information indicating a data amount of at least one of the still image data and the motion picture data.

15. The information recording apparatus according to claim 1, further comprising a communicating device which can communicate with a managing device for managing at least the proprietary information, through an external network.

16. The information recording apparatus according to claim 15, wherein said communicating device registers information to the managing device as the proprietary information, the information indicating at least one of (i) identification information which can identify at least the still image data, (ii) copyright holder identification information which can identify a copyright holder to be protected by copyright protection information about at least the still image data, (iii) a date of reception and registration by the managing device, (iv) a registered place, (v) a data amount of the still image data or the motion picture data, and (vi) a particular block number (or address) in the still image data or the motion picture data, and data corresponding to the block number.

17. The information recording apparatus according to claim 15, wherein
said communicating device transmits not only the proprietary information but also at least the still image data with the proprietary information superimposed, and
the managing device manages not only the proprietary information but also at least the still image data with the proprietary information superimposed.

18. The information recording apparatus according to claim 1, wherein
the information recording medium comprises: (i) a first data area to record therein first data for reproducing contents in accordance with a predetermined format, (ii) a second data area to record therein second data which is reproduced with the first data, and (iii) a third data area to record therein third data which is associated with the second data, and
said recording device (iv) records reproduction control information in the predetermined format into the first data area as the first data, (v) records the motion picture data with the proprietary information superimposed, into the second data area as the second data, and (vi) records the still image data with the proprietary information superimposed, into the third data area as the third data.

19. The information recording apparatus according to claim 18, wherein
the first data is prerecorded in the first data area provided for the information recording medium, and
said recording device does not record the reproduction control information as the first data.

20. The information recording apparatus according to claim 1, wherein the still image data is in an image format based on a JPEG (Join Photographic Experts Group) compression standard.

21. An information recording method comprising:
a converting process of converting still image data to motion picture data with a predetermined resolution;
a generating process of generating proprietary information which includes identification information which can uniquely identify an association between the still image data and the motion picture data, with respect to another still image data and another motion picture data;
a first superimposing process of superimposing the generated proprietary information on the still image data;
a second superimposing process of superimposing the generated proprietary information on the motion picture data; and
a recording process of recording the still image data and the motion picture data with the proprietary information superimposed, onto an information recording medium.

22. A computer program for recording control to control a computer provided in an information recording apparatus, the computer program making the computer function as at least one portion of a converting device, a generating device, a first superimposing device, a second superimposing device, and a recording device,
said information recording apparatus comprising:
said converting device for converting still image data to motion picture data with a predetermined resolution;
said generating device for generating proprietary information which includes identification information which can uniquely identify an association between the still image data and the motion picture data, with respect to another still image data and another motion picture data;
said first superimposing device for superimposing the generated proprietary information on the still image data;
said second superimposing device for superimposing the generated proprietary information on the motion picture data; and
said recording device for recording the still image data and the motion picture data with the proprietary information superimposed, onto an information recording medium.

23. An information recording medium on which still image data and motion picture data with proprietary information superimposed are recorded, the proprietary information being associated with at least one of the still image data and the motion picture data which is converted from the still image data to have a predetermined resolution.

24. The information recording medium according to claim 23, wherein the still image data and the motion picture data with the proprietary information superimposed are recorded on the basis of (i) a DVD format or (ii) a Blu-ray format.

25. The information recording medium according to claim 24, wherein the still image data and the motion picture data with the proprietary information superimposed are recorded on the basis of a hierarchy structure for distinguishing a video area (Video_TS), an audio area (Audio_TS), and another area (User_DATA).

26. An information recording medium to record thereon still image data and motion picture data with proprietary information superimposed are recorded, the proprietary information being associated with at least one of the still image data and the motion picture data which is converted from the still image data to have a predetermined resolution, said information recording medium comprising:
a first data area to record therein first data for reproducing contents in accordance with a predetermined format;
a second data area to record therein motion picture data which is reproduced with the first data and on which the proprietary information is superimposed; and
a third data area to record therein the still picture data which is associated with the motion picture data and on which the proprietary information is superimposed.

27. The information recording medium according to claim 26, wherein the fist data is prerecorded in said first data area.

28. The information recording medium according to claim 23, wherein said information recording medium is used as a recording medium of an electrophotographic album.
